(19) United States
(12) Patent Application Publication
(10) Pub. No.: US 2013/0044048 A1
(43) Pub. Date: Feb. 21, 2013

(54) DISPLAY DEVICE AND METHOD USING ELECTROMAGNETOPHORETIC PROPERTY

(71) Applicants: Jae Hyun Joo, Hwaseong-si (KR); Sung Wan Hong, Gunpo-si (KR)

(72) Inventors: Jae Hyun Joo, Hwaseong-si (KR); Sung Wan Hong, Gunpo-si (KR)

(73) Assignee: Nanobrick Co., Ltd., Suwon-si (KR)

(21) Appl. No.: 13/513,586

(22) PCT Filed: Dec. 2, 2010
(86) PCT No.: PCT/KR2010/008571

§ 371 Date: Aug. 13, 2012

(30) Foreign Application Priority Data
Dec. 2, 2009 (KR) 10-2009-0118388

(51) Int. Cl. G02F 1/167; G09G 3/34

(52) U.S. Cl. 345/107; 359/296

(57) ABSTRACT

The present disclosure relates to a display method and device using an electromagnetophoretic property. The display method includes: applying at least one of an electric field and magnetic field to a plurality of particles configured to possess an electric charge and magnetic property and to exhibit a first color, in a state in which the particles are dispersed in a solvent configured to exhibit a second color, so that at least one of the first and second colors is exhibited; and changing at least one of intensity and orientation of the applied electric field or magnetic field, so that the particles are moved in a predetermined direction to exhibit at least one of the first and second colors.

### TECHNICAL FIELD

The present invention relates to a display device and method using an electromagnetophoretic property. More particularly, the present invention relates to a display device and method using an electromagnetophoretic property to implement a display means by applying an electric field or magnetic field to a plurality of particles to move the particles, in which each of the particles is configured to possess either an electric charge or a magnetic property, and to exhibit a specific color.

### BACKGROUND ART

As research and development for next-generation display means have been actively performed recently, various display means are introduced. An electronic-ink may serve as a representative example of a next-generation display means. The electronic-ink is a display means for exhibiting one or more specific colors (for example, black and white) when an electric field is applied to capsules in the ink, each of which encloses particles configured to possess a negative or positive electric charge and to exhibit one of the specific colors. The electronic-ink is characterized as a display means for exhibiting specific colors, which can reduce power consumption and enable a flexible display.

However, such a conventional electronic-ink has a limit in that it can be driven only by an electric field because it merely includes particles, each of which possesses an electric charge. In addition, the electronic-ink cannot break free of a simple display pattern of an order of being turned ON/OFF depending on the orientation of the applied electric field.

The inventors have made the present invention by conceiving that if either an electric field or magnetic field is applied to particles, each of which possesses an electric charge or a magnetic property, to move the particles, it may be possible to implement a display means excellent in display performance, which has various functions (for example, a function of allowing predetermined information to be displayed by a magnetic pen (i.e., by a magnetic field) and then to be erased by electrodes (i.e., by an electric field), and a function of allowing predetermined information to be displayed by the electric field and then to be corrected by the magnetic field, while being capable of exhibiting various colors.

### DISCLOSURE

### Technical Problem

The present invention has been made to solve the above-mentioned problems. In addition, an aspect of the present invention is to provide a displaying method and device controlled either by an electric field or magnetic field, in which either an electric field or magnetic field is applied to particles to move the particles, in which each of the particles possesses an electric charge and magnetic property, and exhibits a specific color.

### Technical Solution

In accordance with an aspect of the present invention, there is provided a display method using an electromagnetophoretic property, including: applying at least one of an electric field and magnetic field to a plurality of particles configured to possess an electric charge and magnetic property and to exhibit a first color, in a state in which the particles are dispersed in a solvent configured to exhibit a second color, so that at least one of the first and second colors is exhibited; and changing at least one of the intensity and orientation of the applied electric field or magnetic field, so that the particles are moved in a predetermined direction to exhibit at least one of the first and second colors.

In accordance with another aspect of the present invention, there is provided a display method using an electromagnetophoretic property, including: applying at least one of an electric field and magnetic field to a plurality of first particles configured to possess an electric charge and magnetic property and to exhibit a first color, and a plurality of second particles configured to possess an electric charge opposite to that of the first particles without a magnetic property and to exhibit a second color, in a state in which the first and second particles are dispersed in a solvent configured to exhibit a third color, so that at least one of the first, second and third colors is exhibited; and changing at least one of the intensity and orientation of the applied electric field or magnetic field, so that the first particles or the second particles are moved in a predetermined direction to exhibit at least one of the first, second and third colors.

In a case in which the particles are configured to have an electric charge, the particles may be adapted to have the electric charge per se or to have the electric charge by changing a property thereof.

In a case in which the particles are configured to have a magnetic property, the particles may contain at least one of Fe, Co and Ni.

In a case in which the particles are configured to have a magnetic property, the particles may contain a superparamagnetic component.

The particles may contain at least one component selected from a group consisting of a pigment, a dye, a phosphorescent material, a fluorescent material, and a material with a structural color.

The solvent may be composed of a light-transmissive material.

The particles may be encapsulated by capsules formed of a light-transmissive material, or separately contained in plural sections divided by one of more partitions formed of an insulation material in a state in which the particles are dispersed in the solvent.

The solvent may be in a gel phase.

The color exhibited by at least one of the electric field and magnetic field may be adapted to be maintained even after at least one of the magnetic field and electric field is removed.

The color exhibited by at least one of the electric field and magnetic field may be adapted to be maintained even after at least one of the magnetic field and electric field is removed by controlling at least one of the functional groups and specific gravities of the particles and the solvent, and the viscosity of the solvent.

In accordance with another aspect of the present invention, there is provided a display device using an electromagnetophoretic property, including: a display unit including a plurality of particles configured to possess an electric charge and magnetic property and to exhibit a first color, and a solvent configured to exhibit a second color; an electric field generating unit configured to generate an electric field applied to the display unit; and a magnetic field generating unit configured to generate a magnetic field applied to the display unit, wherein at least one of the electric field and magnetic field is applied to the particles in a state in which the particles are dispersed in the solvent, so that at least one of the first and second colors is exhibited, and wherein the particles are moved in a predetermined direction depending on the change of at least one of the intensity and orientation of the applied electric field or magnetic field to exhibit at least one of the first and second colors.

In accordance with still another aspect of the present invention, there is provided a display device using an electromagnetophoretic property, including: a display unit comprising a plurality of first particles configured to possess an electric charge and magnetic property and to exhibit a first color, a plurality of second particles configured to possess an electric charge opposite to that of the first particles without a magnetic property and to exhibit a second color, and a solvent configured to exhibit a third color; an electric field generating unit configured to generate an electric field applied to the display unit; and a magnetic field generating unit configured to generate a magnetic field applied to the display unit, wherein at least one of the electric field and magnetic field is applied to the first and second particles in a state in which the first and second particles are dispersed in the solvent, so that at least one of the first, second and third colors is exhibited, and wherein the first particles or the second particles are moved in a predetermined direction depending on the change of at least one of the intensity and orientation of the applied electric field or magnetic field to exhibit at least one of the first, second and third colors.

The particles may contain at least one component selected from a group consisting of a pigment, a dye, a phosphorescent material, a fluorescent material, and a material with a structural color.

The particles may be encapsulated by capsules formed of a light-transmissive material, or separately contained in plural sections divided by one or more partitions formed of an insulation material in a state in which the particles are dispersed in the solvent.

The color exhibited by at least one of the electric field and magnetic field may be adapted to be maintained even after at least one of the magnetic field and electric field is removed.

The color exhibited by at least one of the electric field and magnetic field may be adapted to be maintained even after at least one of the magnetic field and electric field is removed by controlling at least one of the functional groups and specific gravities of the particles and the solvent, and the viscosity of the solvent.

The inventive display device may further include: a displayed information converting unit configured to convert information regarding a color exhibited by at least one of the electric field and magnetic field with reference to current values generated as an electric field for measurement having a preset orientation and intensity is applied to the moved particles into an electric signal.

### Advantageous Effects

In accordance with the present invention configured as described above, it is possible to provide a display method and device controlled either by an electric field or magnetic field, which makes it possible to implement a function of providing images of various patterns, and an information displaying function, and to implement a display apparatus which is excellent in displaying characteristic.

In addition, in accordance with the present invention, it is possible to implement an electromagnetic blackboard which is configured to display predetermined information using a magnetic pen (i.e., a magnetic field), and thereafter, to erase the entirety or a part of the displayed information by applying an electric field, so that neither dust nor, odor is produced, in contrast to the use of a conventional blackboard. In addition, it is possible to display predetermined information by applying an electric field, and thereafter, to change the displayed information using a magnetic pen, which makes it possible to correct the displayed information or to implement an additional writing function without a complicated apparatus, such as a touch panel. In particular, in accordance with the present invention, it is possible to tune the brightness of displayed information by controlling the intensity of an applied electric field or magnetic field.

Moreover, in accordance with the present invention, it is possible to implement a magnetic sensor by visually expressing a pattern of a surrounding magnetic field using a display device, and to three dimensionally display the pattern of the surrounding magnetic field by configuring the display device in a stack type.

### BRIEF DESCRIPTION OF THE DRAWINGS

The foregoing and other objects, features and advantages of the present invention will become more apparent from the following detailed description when taken in conjunction with the accompanying drawings in which:

FIGS. 1 and 2 illustrate a configuration and an operating principle of a display device in accordance with a first exemplary embodiment of the present invention by way of an example;

FIG. 3 illustrates a configuration for implementing a composite display means by applying an electric field and magnetic field in accordance with a second exemplary embodiment of the present invention;

FIGS. 4 and 5 illustrate a configuration and an operating principle of a display device in accordance with a third exemplary embodiment of the present invention by way of an example; and

FIGS. 6 and 7 illustrate a configuration and an operating principle of a display device in accordance with a fourth embodiment of the present invention by way of an example.

### REFERENCE NUMERALS

100, 200, 300, 400, 500, 600, 700: display device
110, 210, 310, 410, 510, 610, 710: display unit
112, 212, 312, 612, 712: particles
114, 214, 314, 416, 516, 618, 718: solvent
412, 512: first particles
414, 514: second particles
614, 714: first part
616, 716: second part
120, 220, 322, 324, 326, 420, 520, 620, 720: electric field generating unit
230, 330, 530, 630, 730: magnetic field generating unit

### BEST MODE

### Mode for Invention

The following description of the present invention will be made with reference to the accompanying drawings which illustrate various exemplary embodiments for practicing the present invention by way of an example. It shall be noted that the various embodiments are different from each other but need not to be exclusive to each other. For example, a specific shape, configuration and characteristic of an exemplary embodiment described herein may be implemented in another exemplary embodiment without departing from the spirit and scope of the present invention. In addition, it shall be understood that a position or arrangement of an individual component in each of the exemplary embodiments disclosed herein may be changed without departing from the spirit and scope of the present invention. Therefore, the following detailed description is not intended to limit the present invention, and the scope of the present invention, when it is properly described, covers all the equivalents to the claimed invention and is limited only by the accompanying claims. Similar reference numerals indicate components with identical or similar functions from various aspects.

Hereinafter, the present invention will be described in detail with reference to the accompanying drawings in order to allow a person ordinarily skilled in the art to fully understand the present invention.

At first, particles included in the inventive display device will be discussed in detail below.

The inventive particles may possess a negative or positive electric charge so that the particles may be moved when electric force is applied thereto by an electric field (i.e., the particles may be electrophoretically moved), in which it is possible to make each of the particles possess an electric charge per se, by coating the particle with an electrically charged material, or by making the particle react with a solvent in such a manner that the property of the particle may be changed to possess an electric charge.

More specifically, the particles in accordance with an exemplary embodiment of the present invention may exist as metal particles, polymer particles, inorganic particles, semiconductor particles or a combination thereof. For example, the particles in accordance with an exemplary embodiment of the present invention may be formed from an element selected from silicon (Si), titanium (Ti), carbon (c), barium (Ba), strontium (Sr), iron (Fe), nickel (Ni), cobalt (Co), lead (Pb), aluminum (Al), copper (Cu), silver (Ag), gold (Au), tungsten (W), molybdenum (Mo), zinc (Zn), zirconium (Zr) or a compound containing at least one of these elements. In accordance with another exemplary embodiment of the present invention, the particles may be formed from a polymer, for example, polystyrene (PS), polyethylene (PE), polypropylene (PP), polyvinyl chloride (PVC), polyethylene terephthalate (PET). In accordance with another exemplary embodiment of the present invention, the particles may be formed by coating an electrically charged material on non-charged particles or clusters, which may include, for example, particles surface-treated (or coated) with an organic compound having a hydrocarbon group, particles surface-treated (or coated) with an organic compound having carboxylic acid group, ester group, or acyl group, particles surface-treated (or coated) with an complex compound containing a halogen element (F, Cl, Br, I or the like), particles surface-treated (or coated) with a coordination compound containing amine, thiol, or phosphine, and particles charged by forming radicals on surface thereof. Furthermore, quantum dots, fluorescent materials or phosphorescent materials may be used to form the inventive particles.

The inventive particles may possess a magnetic property so that they can be moved by being subjected to magnetic force of a magnetic field (i.e. the particles may be magnetophoretically moved), in which the particles may contain a magnetic material, for example, nickel (Ni), iron (Fe), cobalt (Co) or the like. In particular, in accordance with an exemplary embodiment of the present invention, in order to prevent the particles possessing a magnetic property from agglomerating with each other due to residual magnetization when no magnetic field is applied from the outside, it is possible to employ a superparamagnetic material, which has a high magnetic saturation value but has a low magnetic remnant value.

In addition, each of the inventive particles may be configured to exhibit a predetermined color to be capable of reflecting a light beam of a predetermined wavelength. More specifically, each of the inventive particles may be provided with a predetermined color through an adjustment of oxidation number or coating of an inorganic pigment or a dye. For example, as an inorganic pigment to be coated on the inventive particles, Zn, Pb, Ti, Cd, Fe, As, Co, Mg, Al or the like, which includes a chromophore, may be used in the form of oxide, sulfide or sulphate, and as a dye to be coated on the inventive particles, a fluorescent dye, an acid dye, a basic dye, a mordant dye, a sulfur dye, a vat dye, a disperse dye, a reactive dye or the like may be used.

It is possible to use a material exhibiting a predetermined structural color to make the inventive particles exhibit a predetermined color. For example, materials configured by evenly distributing fine particles of a silicon oxide (SiOₓ) or a titanium oxide (TiOₓ) at regular spaces on mediums, of which the refractive indexes are different from each other, to reflect specific wavelengths, respectively, may be used to form the inventive particles.

In addition, the inventive particles may be coated with a silica, a polymer, a monomer or the like in order to make the particles be highly dispersive and stable in a solvent.

Meanwhile, the diameters of the inventive particles may be in but not exclusively limited to the range of scores of nanometers to scores of micrometers.

Next, a configuration of a solvent contained in the inventive display device will be described in detail.

The inventive solvent may be formed from a material having a specific gravity similar to that of the particles, and may be formed from a material suitable for securing an electrophoretic property or a magnetophoretic property and bistability of the particles. For example, the material may include a material having a low permittivity, such as halogen carbon oil and dimethyl silicon oil, or a material having a polarity index higher than 1, such as tetrahydrofuran, acetonitrile, and propylene carbonate.

In addition, the inventive solvent may be configured to exhibit a specific color by containing a material reflecting a light beam of a predetermined wavelength (for example, a color ink, a color dye, a color pigment or the like), or configured to be transparent (i.e., not to exhibit a specific color). In particular, if the solvent is transparent, a color formed by mixing the colors of the particles and the color of a bottom substrate may be exhibited depending on the changes of positions of the particles depending on an external electric field or magnetic field applied thereto.

However, the configurations of the inventive particles and solvent are not limited to those enumerated above, and may be properly changed within the scope of achieving the purpose of the present invention.

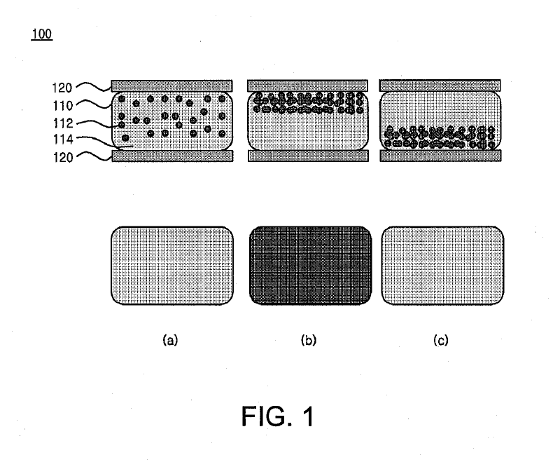

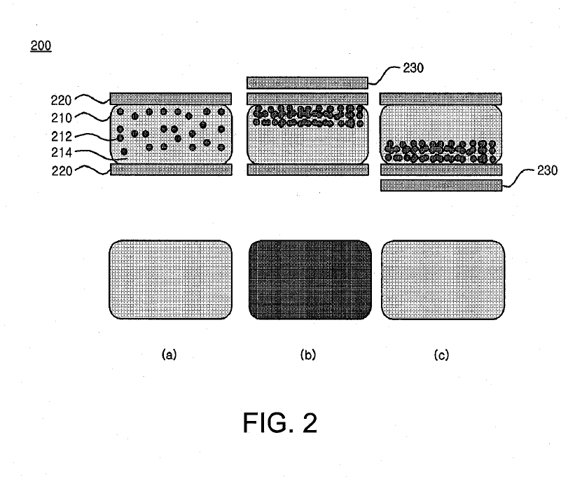

FIGS. 1 and 2 illustrate a configuration and operating principle of a display device in accordance with the first exemplary embodiment of the present invention by way of an example.

Referring to FIGS. 1 and 2, the display device 100 or 200 in accordance with the first exemplary embodiment of the present invention may include a display unit 110 or 210, an electric field generating unit 120 or 220, and a magnetic field generating unit 230, in which the display unit 110 or 210 may include particles 112 or 212 configured to possess an electric charge and magnetic property and to reflect a light beam of a first wavelength (i.e., first color) and dispersed in a solvent 114 or 214 configured to reflect a light beam of a second wavelength (i.e., second color).

In accordance with the first exemplary embodiment of the present invention, the display unit 110 or 210 performs a function for exhibiting the first color or second color in accordance with the intensity and orientation of the electric field or magnetic field, which can be implemented as the particles of the first color 112 or 212 contained in the display unit 110 or 210 are moved to the top or bottom of the display unit 110 or 210 in accordance with the intensity and orientation of the electric field or magnetic field applied to the display unit 110 or 210. More specifically, when the particles 112 or 212 of the first color are moved to the top of the display unit 110 or 210, the display unit 110 or 210 will exhibit the first color, and when the particles 110 or 210 are moved to the bottom of the display unit 110 or 210, the display unit 110 or 210 will exhibit the second color.

In addition, in accordance with the first exemplary embodiment of the present invention, the electric field generating unit 120 or 220 functions to apply a predetermined electric field to the display unit 110 or 210, and the intensity and orientation of the electric field applied through the electric field generating unit 120 or 220 may be properly controlled to be suitable for the color desired to be exhibited on the display unit 110 or 210. In accordance with the first exemplary embodiment of the present invention, the electric field generating unit 120 or 220 may be formed of a light-transmissive material not to disturb the progress of light reflected from the display unit 110 or 210, for example, indium tin oxide (ITO), which is a transparent electrode material, titanium dioxide (TiO₂), carbon nanotubes, graphene, an electro-conductive polymer film or the like.

In addition, in accordance with the first exemplary embodiment of the present invention, the magnetic field generating unit 230 may include an electromagnet (not shown) and a coil (not shown) so as to control the intensity and orientation of the magnetic field applied to the display unit 210. Furthermore, the magnetic field generating unit 230 in accordance with the first exemplary embodiment may configured in the form of a magnetic pole fixedly installed at a predetermined portion of the display device 200, or in the form of a pen to be capable of being manipulated by a user to apply a magnetic field to an optional area on the display unit 210.

More specifically, referring to FIG. 1, when no electric field is applied to the display unit 110 (FIG. 1(a)), the particles 112 exhibiting the first color may be irregularly arranged, which may cause the display unit 110 to exhibit a color formed by mixing the first color by the particles 112 and the second color by the solvent 114.

Continuously referring to FIG. 1, when a predetermined electric field is applied to the display unit 110 (FIG. 1(b)), the particles 112 exhibiting the first color may be moved to the top of the display unit 110 by being subjected to electric force oriented upward, which allows the display unit 110 to exhibit the first color mainly under the influence of the particles 112 exhibiting the first color.

Continuously referring to FIG. 1, if an opposite electric field is applied to the display unit 110 (FIG. 1(c)), the particles 112 exhibiting the first color may be moved to the bottom of the display unit 110 by being subjected to electric force oriented downward, which allows the display unit 110 to exhibit the second color mainly under the influence of the solvent 114 exhibiting the second color.

Referring to FIG. 2, when no magnetic field is applied to the display unit 210 (FIG. 2(a)), the particles 212 exhibiting the first color may be irregularly arranged, which allows the display unit 210 to exhibit a color formed by mixing the first color by the particles 212 and the second color by the solvent 214.

Continuously referring to FIG. 2, when a predetermined magnetic field is applied to the display unit 210 (FIG. 2(b)), the particles 212 exhibiting the first color may be moved to the top of the display unit 210 by being subjected to magnetic force oriented upward, which allows the display unit 210 to exhibit the first color mainly under the influence of the particles 212 exhibiting the first color.

Continuously referring to FIG. 2, if an opposite magnetic field is applied to the display unit 210 (FIG. 2(c)), the particles 212 exhibiting the first color may be moved to the bottom of the display unit 210 by being subjected to magnetic force oriented downward, which allows the display unit 210 to exhibit the second color mainly under the influence of the solvent 214 exhibiting the second color.

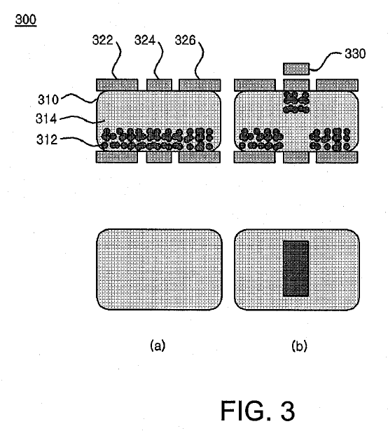

FIG. 3 illustrates a configuration for implementing a composite display means by applying an electric field and magnetic field in accordance with the second exemplary embodiment of the present invention by way of an example.

In accordance with the second exemplary embodiment of the present invention, the electric field generating unit 322, 324 and 326 may be configured by a plurality of electrodes 322, 324 and 326 which are capable of independently applying an electric field to an area of the display unit 310 so as to more elaborately and independently control the particles contained in the display unit 310, in which the electrodes 322, 324 and 326 may be individually controlled by a driving circuit, such as a thin film transistor (TFT).

Referring to FIG. 3, when an electric field oriented to move the particles 312 of the first color to the bottom of the display unit 310 is applied to the entire area of the display unit 310 using the electric field generating unit 322, 324 and 326, the displaying condition of the display unit 310 may be initialized to the second color (FIG. 3(a)).

Continuously referring to FIG. 3, when power supply to one or more selected electrodes 324 among the electrodes 322, 324 and 326 of the electric field generating unit is shut off so that no electric field is applied between the corresponding electrodes 324, and at the same time, a predetermined magnetic field is applied between the corresponding electrodes 324 using the magnetic field generating unit 330, only the particles 312 of the first color positioned in the area of the display unit 310 between the corresponding electrodes 324 can be moved to the top of the display unit 310, which may cause the corresponding area of the display unit 310 to exhibit the first color (FIG. 3(b)).

As described above, in accordance with the second exemplary embodiment of the present invention, it is possible to implement both the “writing” function and “erasing” function of the display device 300 by properly controlling the orientation and intensity of the electric field or magnetic field applied to the display unit 310. In addition, the inventive configuration may be used in combination with a touch screen. For example, if an electric field or magnetic field is adapted to be locally applied only to a portion pressed by a user on a touch screen to induce a change of color only in the portion, the “writing” and “erasing” functions can be implemented more efficiently.

The particles contained in the display unit of the inventive display device may be encapsulated by a plurality of capsules (not shown) formed of a light-transmissive material, or may be separately contained in plural sections divided by one or more partitions formed of an insulation material in a state in which the particles are dispersed in a solvent. In accordance with an exemplary embodiment of the present invention, by encapsulating or partitioning the particles contained in the display unit, it is possible to prevent direct interference, for example, mixing, between the particles contained in different capsules or different sections, which makes it possible to independently control the particles contained in the display unit from capsule to capsule or from section to section. As a result, it is possible to provide images of more diversified patterns, and to implement a display means which is excellent in displaying characteristic.

For example, gelatin, acacia, melamine, urea, protein, polysaccharide or the like may be used as a material to form the capsules in accordance with the exemplary embodiment of the present invention, and a mixture of polyvinyl alcohol, polyurethane or the like may be used as a material for fixing the capsules in the display unit. However, the present invention is not necessarily limited to these materials.

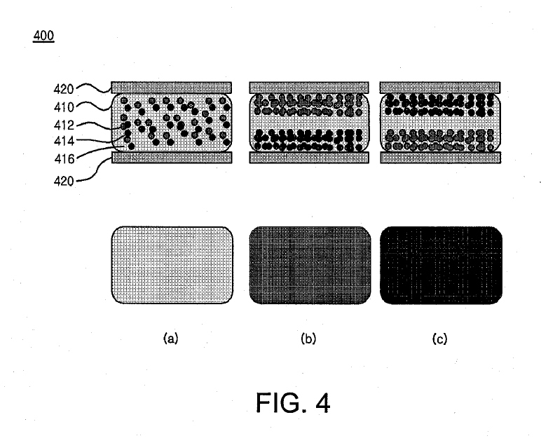

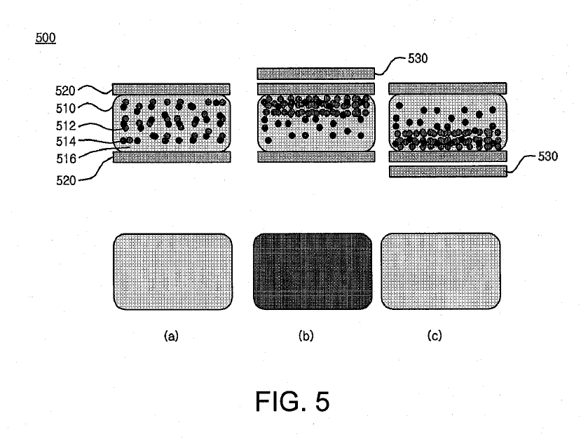

Meanwhile, FIGS. 4 and 5 illustrate a configuration and operating principle of a display device in accordance with a third exemplary embodiment of the present invention.

Referring to FIGS. 4 and 5, the display device 400 or 500 in accordance with the third exemplary embodiment of the present invention may include a display unit 410 or 510, an electric field generating unit 420 or 520, and a magnetic field generating unit 530, in which the display unit 410 or 510 may contain first particles 412 or 512 and second particles 414 or 514 which reflect first and second light beams of first and second wavelengths (first and second colors), respectively, in a state in which they are dispersed in a solvent 416 or 516 which may be light-transmissive or reflect a light beam of a third wavelength (that is, third color). Since the configurations of the display units 410 and 510, the electric field generating units 420 and 520, and the magnetic field generating unit 530 included in the display devices 400 and 500 have been fully described above, a further detailed description thereof will be omitted. Hereinafter, the configurations of the first and second particles included in the display units 410 and 510 in accordance with the third exemplary embodiment of the present invention, and the operations of the display device 400 and 500 resulting therefrom will be described in detail.

In accordance with the third embodiment of the present invention, the first particles may be configured to possess an electric charge and magnetic property, whereas the second particles may be configured to possess an electric charge only, in which the electric charges of the first and second particles are opposite to each other. In such a case, the first particles contained in the display unit may be moved either by an electric field or by a magnetic field, and the second particles may be moved only by an electric field, in which various patterns of images may be displayed in accordance with the moving aspects of the first and second particles, which exhibit the first and second colors, respectively.

More specifically, referring to FIG. 4, when neither an electric field nor a magnetic field is applied to the display unit 410 (FIG. 4(a)), the first particles 412 exhibiting the first color and the second particles 414 exhibiting the second color may be irregularly arranged, which allows the display unit 410 to display a color formed by mixing the first, second and third colors. At this time, if the solvent 416 is light-transmissive, a color formed by mixing the first and second colors may be displayed.

Continuously referring to FIG. 4, when an electric field is applied to the display unit 410 (FIG. 4(b)), the first particles 412 exhibiting the first color may be moved to the top of the display unit 410 by being subjected to electric force oriented upward, and the second particles 414 exhibiting the second color may be moved to the bottom of the display unit 410 by being subjected to electric force oriented downward, which allows the display unit 410 to display the first color mainly under the influence of the first particles 412 exhibiting the first color.

Continuously referring to FIG. 4, when an opposite electric field is applied to the display unit 410 (FIG. 4(c)), the first particles 412 exhibiting the first color may be moved to the bottom of the display unit 410 by being subjected to electric force oriented downward, and the second particles 414 exhibiting the second color may be moved to the top of the display unit 410 by being subjected to electric force oriented upward, which allows the display unit 410 to display the second color mainly under the influence of the second particles 414 exhibiting the second color.

Referring to FIG. 5, when neither an electric field nor a magnetic field is applied to the display unit 510 (FIG. 5(a)), the first particles 512 exhibiting the first color and the second particles 514 exhibiting the second color may be irregularly arranged, which allows the display unit 510 to display a color formed by mixing the first, second and third colors. At this time, if the solvent 516 is light-transmissive, a color formed by mixing the first and second colors may be displayed.

Continuously referring to FIG. 5, when a magnetic field is applied to the display unit 510 (FIG. 5(b)), the first particles 512 exhibiting the first color may be moved to the top of the display unit 510 by being subjected to magnetic force oriented upward, and the second particles 514 exhibiting the second color may be still arranged irregularly, which allows the display unit 510 to display the first color mainly under the influence of the first particles 512 exhibiting the first color.

Continuously referring to FIG. 5, when an opposite magnetic field is applied to the display unit 510 (FIG. 5(c)), the first particles 512 exhibiting the first color may be moved to the bottom of the display unit 510 by being subjected to magnetic force oriented downward, and the second particles 514 exhibiting the second color may be still arranged irregularly, which allows in turn the display unit 510 to display the third color mainly under the influence of the solvent 516 exhibiting the third color. At this time, if the solvent 516 is light-transmissive, a color formed by mixing the first and second colors may be displayed.

In accordance with the exemplary embodiments of the present invention, it is possible to keep the positions of the particles fixed even if an electric field or magnetic field is removed after the electric field or magnetic field is applied to the particles to move or rotate the particles by limiting the movement of the particles in the solvent, which allows the colors implemented by the electric field or magnetic field to be fixedly and stably maintained. That is, the particles may be electrophoretically or magnetophoretically moved by an electric field or magnetic field applied thereto from the outside to implement one or more colors, and the implemented colors can be maintained in a predetermined length of time or permanently as the movement of the particles in the solvent is limited even if the applied electric field or magnetic field is removed.

In accordance with an exemplary embodiment of the present invention, in order to limit the movement of the particles in the solvent, it is possible to coat or add a functional group to each of the particles and the solvent such that the movement of the particles is limited due to the interaction between the particles and the solvent, or to set the difference of the specific gravities between the particles and the solvent to be not higher than a predetermined value, or to set the viscosity of the solvent to be not lower than a predetermined value. In particular, in accordance with an exemplary embodiment of the present invention, it is possible to employ a highly viscous gel-phase solvent.

In addition, in accordance with an exemplary embodiment of the present invention, it is possible to provide a separate device capable of storing electric charges or residual magnetic poles (for example, a capacitor, a ferromagnetic body or the like), so that the electric or magnetic energy induced by the applied electric field or magnetic field can be stored and used to maintain a corresponding color after the electric field or magnetic field is removed.

As discussed above, in accordance with the present invention, it is possible to implement various colors on a display device continuously and in combination, and to implement various colors, chromas and brightnesses by combining the colors of the particles and solvent.

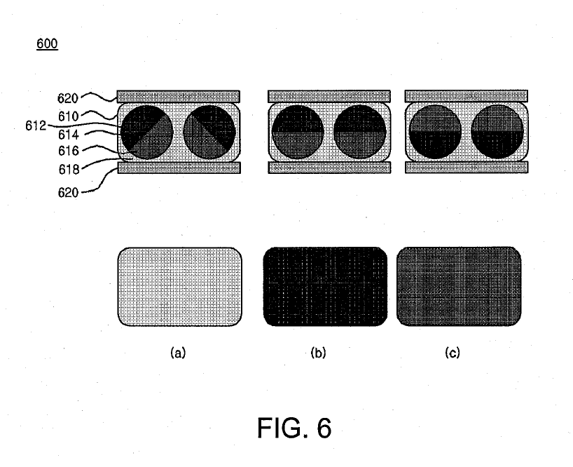

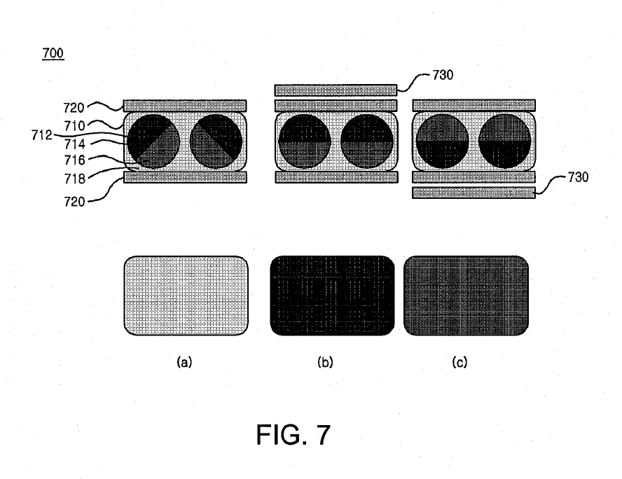

FIGS. 6 and 7 illustrate a configuration and operating principle of a display device in accordance with the fourth exemplary embodiment of the present invention by way of an example.

Referring to FIGS. 6 and 7, the display device 600 or 700 in accordance with the fourth exemplary embodiment of the present invention may include a display unit 610 or 710, an electric field generating unit 620 or 720, and a magnetic field generating unit 730, in which the display unit 610 or 710 may contain particles 612 or 712, each of which is composed of a first part 614 or 714 configured to possess an electric charge and magnetic property and to reflect a light beam of a first wavelength (i.e., first color), and a second part 616 or 716 configured to possess an electric charge and magnetic property opposite to those of the first part and to reflect a light beam of a second wavelength (i.e., second color), and the display unit 610 and 710 may include a solvent 618 or 718 which may be light-transmissive or reflect a light beam of a third wavelength (i.e., third color).

Since the configurations of the display units 610 and 710, the electric field generating units 620 and 720, and the magnetic field generating unit 730 included in the display devices 600 and 700 have been fully described above, a detailed description thereof will be omitted. Hereinafter, the configurations of the first and second particles included in the display units 610 and 710 in accordance with the fourth exemplary embodiment of the present invention, and the operations of the display devices 600 and 700 resulting therefrom will be described in detail.

At first, referring to FIG. 6, when neither an electric field nor a magnetic field is applied to the display unit 610 (FIG. 6(a)), the particles 612 are not fixed to a specific orientation, so that the first parts 614 exhibiting the first color and the second parts 616 exhibiting the second color may be arranged irregularly, which allows the display unit 610 to display a color formed by mixing the first, second and third colors. At this time, if the solvent 618 is light-transmissive, a color formed by mixing the first and second colors may be displayed.

Continuously referring to FIG. 6, when an electric field is applied to the display unit 610 (FIG. 6(b)), the particles 612 may be rotated and fixed to a specific orientation by being subjected to electric force, so that the first parts 614 exhibiting the first color may be oriented toward the top of the display unit 610, and the second parts 616 exhibiting the second color may be oriented toward the bottom of the display unit 610. In such a case, the display unit 610 may display the first color mainly under the influence of the first parts 614 exhibiting the first color.

Continuously referring to FIG. 6, when an opposite electric field is applied to the display unit 610 (FIG. 6(c)), the particles 612 may be rotated in the opposite direction and fixed to the opposite orientation by being subjected to electric force, so that the first parts 614 exhibiting the first color are oriented toward the bottom of the display unit 610 and the second parts 616 exhibiting the second color are oriented toward the top of the display unit 610. In such a case, the display unit 610 may display the second color mainly under the influence of the second parts 616 exhibiting the second color.

Referring to FIG. 7, when neither an electric field nor a magnetic field is applied to the display unit 710 (FIG. 7(a)), the particles 712 are not fixed to a specific orientation, so that the first parts 714 exhibiting the first color and the second parts 716 exhibiting the second color may be arranged irregularly, which allows the display unit 710 to display the third color mainly under the influence of the solvent 718 exhibiting the third color. At this time, if the solvent 718 is light-transmissive, a color formed by mixing the first and second colors may be displayed.

Continuously referring to FIG. 7, when a magnetic field is applied to the display unit 710 (FIG. 7(b)), the particles 712 may be rotated and fixed to a specific orientation by being subjected to magnetic force, so that the first parts 714 exhibiting the first color may be oriented toward the top of the display unit 710, and the second parts 716 exhibiting the second color may be oriented toward the bottom of the display unit 710. In such a case, the display unit 710 may display the first color mainly under the influence of the first parts 714 exhibiting the first color.

Continuously referring to FIG. 7, when an opposite magnetic field is applied to the display unit 710 (FIG. 7(c)), the particles 712 may be rotated in the opposite direction and fixed to the opposite orientation by being subjected to magnetic force, so that the first parts 714 exhibiting the first color are oriented toward the bottom of the display unit 710 and the second parts 716 exhibiting the second color are oriented toward the top of the display unit 710. In such a case, the display unit 710 may display the second color mainly under the influence of the second parts 716 exhibiting the second color.

In accordance with an exemplary embodiment of the present invention, it is possible to convert a color pattern displayed on the display device in accordance with the above-mentioned configuration into a separate electric signal, and to store the electric signal. That is, when an electric field is applied to the display device in a state in which the particles are moved to a predetermined position by a magnetic field applied to the display device, current values are varied depending on the position of the particles. By using this phenomenon, it is possible to convert a color pattern displayed on the display device into a separate electric signal and to store the electric signal.

More specifically, in accordance with an exemplary embodiment of the present invention, after particles in all pixels of a display device are moved to the same position by applying an electric field not less than a preset level to the display device, (i.e., after the display device is initialized), it is possible to move the particles in each of the pixels to a predetermined position by applying a magnetic field of a predetermined pattern through a magnetic field applying means, such as a magnetic pen or the like (i.e., writing). In such a state, if a predetermined electric field is applied to each of the pixels of the display device, current values are differently exhibited depending on the positions of the particles moved by the magnetic field. By measuring and storing the current value for each of the pixels of the display device, it is possible to convert the information visually expressed on the displaying device into an electric signal. For this purpose, a display device in accordance with an exemplary embodiment of the present invention may include top and bottom electrodes patterned to each of the pixels, and an expressed information converting unit configured to convert expressed information into an electric signal with reference to the measured current values.

Therefore, in accordance with the inventive display device, it is possible to transfer information displayed on a display device to any other display device so as to display the information as it is through the other display device, or to print the information displayed on the display device through a printing device.

While the invention has been described in connection with specific aspects, such as specific components, with reference to specific exemplary embodiments illustrated in the drawings, the description is provided merely to help the wider understanding of present invention but the present invention is not limited to the exemplary embodiments, and a person ordinarily skilled in the art can conceive various modifications and changes from the description.

Therefore, the spirit and scope of the present invention cannot be determined merely relying on the exemplary embodiments described above, and all the equivalents, modifications and changes to the claimed invention as well as the subject matters of the claims belong to the spirit and scope of the present invention.

1. A display method using an electromagnetophoretic property, comprising:
applying at least one of an electric field and magnetic field to a plurality of particles configured to possess an electric charge and magnetic property and to exhibit a first color, in a state in which the particles are dispersed in a solvent configured to exhibit a second color, so that at least one of the first and second colors is exhibited; and
changing at least one of the intensity and orientation of the applied electric field or magnetic field, so that the particles are moved in a predetermined direction to exhibit at least one of the first and second colors.

2. A display method using an electromagnetophoretic property, comprising:
applying at least one of an electric field and magnetic field to a plurality of first particles configured to possess an electric charge and magnetic property and to exhibit a first color, and a plurality of second particles configured to possess an electric charge opposite to that of the first particles without a magnetic property and to exhibit a second color, in a state in which the first and second particles are dispersed in a solvent configured to exhibit a third color, so that at least one of the first, second and third colors is exhibited; and
changing at least one of the intensity and orientation of the applied electric field or magnetic field, so that the first particles or the second particles are moved in a predetermined direction to exhibit at least one of the first, second and third colors.

3. The display method as claimed in claim 1, wherein in a case in which the particles are configured to have an electric charge, the particles are adapted to have the electric charge per se or to have the electric charge by changing a property thereof.

4. The display method as claimed in claim 1, wherein in a case in which the particles are configured to have a magnetic property, the particles contain at least one of Fe, Co and Ni.

5. The display method as claimed in claim 1, wherein in a case in which the particles are configured to have a magnetic property, the particles contain a superparamagnetic component.

6. The display method as claimed in claim 1, wherein the particles contain at least one component selected from a group consisting of a pigment, a dye, a phosphorescent material, a fluorescent material, and a material with a structural color.

7. The display method as claimed in claim 1, wherein the solvent is composed of a light-transmissive material.

8. The display method as claimed in claim 1, wherein the particles are encapsulated by capsules formed of a light-transmissive material, or separately contained in plural sections divided by one of more partitions formed of an insulation material in a state in which the particles are dispersed in the solvent.

9. The display method as claimed in claim 1, wherein the solvent is in a gel phase.

10. The display method as claimed in claim 1, wherein the color exhibited by at least one of the electric field and magnetic field is adapted to be maintained even after at least one of the magnetic field and electric field is removed.

11. The display method as claimed in claim 10, wherein the color exhibited by at least one of the electric field and magnetic field is adapted to be maintained even after at least one of the magnetic field and electric field is removed by controlling at least one of the functional groups and specific gravities of the particles and the solvent, and the viscosity of the solvent.

12. A display device using an electromagnetophoretic property, comprising:
a display unit comprising a plurality of particles configured to possess an electric charge and magnetic property and to exhibit a first color, and a solvent configured to exhibit a second color;
an electric field generating unit configured to generate an electric field applied to the display unit; and
a magnetic field generating unit configured to generate a magnetic field applied to the display unit,
wherein at least one of the electric field and magnetic field is applied to the particles in a state in which the particles are dispersed in the solvent, so that at least one of the first and second colors is exhibited, and
wherein the particles are moved in a predetermined direction depending on the change of at least one of the intensity and orientation of the applied electric field or magnetic field to exhibit at least one of the first and second colors.

13. A display device using an electromagnetophoretic property, comprising:
a display unit comprising a plurality of first particles configured to possess an electric charge and magnetic property and to exhibit a first color, a plurality of second particles configured to possess an electric charge opposite to that of the first particles without a magnetic property and to exhibit a second color, and a solvent configured to exhibit a third color;
an electric field generating unit configured to generate an electric field applied to the display unit; and
a magnetic field generating unit configured to generate a magnetic field applied to the display unit,
wherein at least one of the electric field and magnetic field is applied to the first and second particles in a state in which the first and second particles are dispersed in the solvent, so that at least one of the first, second and third colors is exhibited, and
wherein the first particles or the second particles are moved in a predetermined direction depending on the change of at least one of the intensity and orientation of the applied electric field or magnetic field to exhibit at least one of the first, second and third colors.

14. The displaying device as claimed in claim 12, wherein the particles contain at least one component selected from a group consisting of a pigment, a dye, a phosphorescent material, a fluorescent material, and a material with a structural color.

15. The display device as claimed in claim 12, wherein the particles are encapsulated by capsules formed of a light-transmissive material, or separately contained in plural sections divided by one or more partitions formed of an insulation material in a state in which the particles are dispersed in the solvent.

16. The display device as claimed in claim 12, wherein the color exhibited by at least one of the electric field and magnetic field is adapted to be maintained even after at least one of the magnetic field and electric field is removed.

17. The display device as claimed in claim 16, wherein the color exhibited by at least one of the electric field and magnetic field is adapted to be maintained even after at least one of the magnetic field and electric field is removed by controlling at least one of the functional groups and specific gravities of the particles and the solvent, and the viscosity of the solvent.

18. The display device as claimed in claim 12, further comprising:
a displayed information converting unit configured to convert information regarding a color exhibited by at least one of the electric field and magnetic field with reference to current values generated as an electric field for measurement having a preset orientation and intensity is applied to the moved particles into an electric signal.

19. The display method as claimed in claim 2, wherein in a case in which the particles are configured to have an electric charge, the particles are adapted to have the electric charge per se or to have the electric charge by changing a property thereof.

20. The display method as claimed in claim 2, wherein in a case in which the particles are configured to have a magnetic property, the particles contain at least one of Fe, Co and Ni.

21. The display method as claimed in claim 2, wherein in a case in which the particles are configured to have a magnetic property, the particles contain a superparamagnetic component.

22. The display method as claimed in claim 2, wherein the particles contain at least one component selected from a group consisting of a pigment, a dye, a phosphorescent material, a fluorescent material, and a material with a structural color.

23. The display method as claimed in claim 2, wherein the solvent is composed of a light-transmissive material.

24. The display method as claimed in claim 2, wherein the particles are encapsulated by capsules formed of a light-transmissive material, or separately contained in plural sections divided by one of more partitions formed of an insulation material in a state in which the particles are dispersed in the solvent.

25. The display method as claimed in claim 2, wherein the solvent is in a gel phase.

26. The display method as claimed in claim 2, wherein the color exhibited by at least one of the electric field and magnetic field is adapted to be maintained even after at least one of the magnetic field and electric field is removed.

27. The display method as claimed in claim 26, wherein the color exhibited by at least one of the electric field and magnetic field is adapted to be maintained even after at least one of the magnetic field and electric field is removed by controlling at least one of the functional groups and specific gravities of the particles and the solvent, and the viscosity of the solvent.

28. The displaying device as claimed in claim 13, wherein the particles contain at least one component selected from a group consisting of a pigment, a dye, a phosphorescent material, a fluorescent material, and a material with a structural color.

29. The display device as claimed in claim 13, wherein the particles are encapsulated by capsules formed of a light-transmissive material, or separately contained in plural sections divided by one or more partitions formed of an insulation material in a state in which the particles are dispersed in the solvent.

30. The display device as claimed in claim 13, wherein the color exhibited by at least one of the electric field and magnetic field is adapted to be maintained even after at least one of the magnetic field and electric field is removed.

31. The display device as claimed in claim 30, wherein the color exhibited by at least one of the electric field and magnetic field is adapted to be maintained even after at least one of the magnetic field and electric field is removed by controlling at least one of the functional groups and specific gravities of the particles and the solvent, and the viscosity of the solvent.

32. The display device as claimed in claim 13, further comprising:
a displayed information converting unit configured to convert information regarding a color exhibited by at least one of the electric field and magnetic field with reference to current values generated as an electric field for measurement having a preset orientation and intensity is applied to the moved particles into an electric signal.
